(19) United States
(12) Patent Application Publication
(10) Pub. No.: US 2016/0153187 A1
(43) Pub. Date: Jun. 2, 2016

(54) SOUND DAMPING SYSTEM

(71) Applicant: PPG Industries Ohio, Inc., Cleveland, OH (US)

(72) Inventors: Umesh C. Desai, Wexford, PA (US); Ion Pelinescu, Wexford, PA (US); Tien-Chieh Chao, Mars, PA (US)

(21) Appl. No.: 14/556,309

(22) Filed: Dec. 1, 2014

(51) Int. Cl. E04B 1/84; B32B 7/12; B32B 13/12

(52) U.S. Cl. CPC E04B 1/8409; B32B 13/12; B32B 7/12; B32B 2264/025; B32B 2264/06; B32B 2307/102; B32B 2607/02; B32B 2419/04; B32B 2419/06

(57) ABSTRACT

A laminated panel is disclosed that includes a first layer having an internal surface and an external surface, a second layer having an internal surface and an external surface, and a glue layer extending therebetween. The glue layer is produced from an aqueous dispersion of polymeric acrylic microparticles.

### FIELD OF THE INVENTION

The present invention relates to laminated panels suitable for sound and vibration damping.

### BACKGROUND OF THE INVENTION

Soundproofing of walls, ceilings, and floors in residential and industrial buildings is a continuing economic and public policy concern within the construction industry. Many buildings require rooms with walls, ceilings, and floors that reduce the transmission of sound, thereby minimizing or eliminating disturbance to people in adjacent rooms. Likewise, in entertainment venues, such as theatres and music practice rooms, recording studios and the like, noise abatement is desirable. Similarly, healthcare facilities, such as hospitals, require quiet environments.

One measure of the soundproofing of an environment is the Sound Transmission Class (STC) ratings, which can be determined according to ASTM standard E413. The STC is calculated based on the sound that is absorbed by a partition, referred to as the Sound Transmission Loss (STL), typically measured in decibels (dB). STC is a rating of how well a building structure attenuates airborne sound. An STC of 25 indicates that speech can be readily understood through a partition, whereas an STC rating of 60 or more indicates that most sounds are inaudible through a partition.

### SUMMARY OF THE INVENTION

The present invention includes a laminated panel comprising a first layer having an internal surface and an external surface, a second layer having an internal surface and a second surface, and a glue layer extending between and at least partially covering the internal surfaces of the first and second layers. The glue layer is produced from an aqueous dispersion of polymeric microparticles and may further include rosin. Also included in the present invention is a laminated panel comprising a first portion comprising a constrained layer of viscoelastic material and a second portion comprising an extensional layer of viscoelastic material.

### DETAILED DESCRIPTION OF THE DRAWINGS

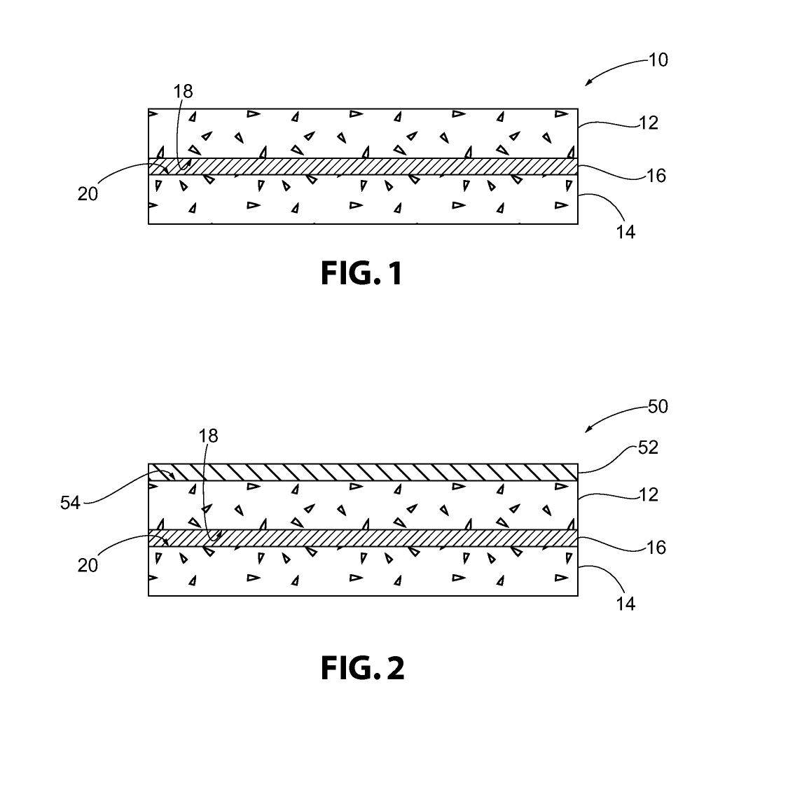

FIG. 1 is a cross-section of a laminated panel according to the present invention;

FIG. 2 is a cross-section of a laminated panel according to the present invention;

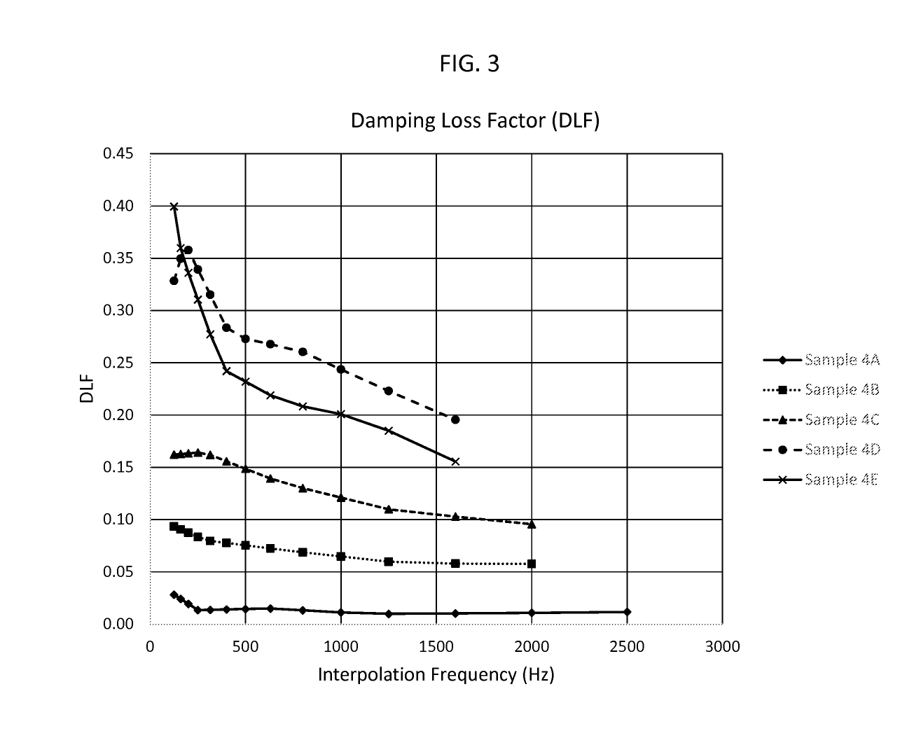

FIG. 3 is a graph comparing the damping loss factor (DLF) as a function of the linear interpolation frequencies for several panels;

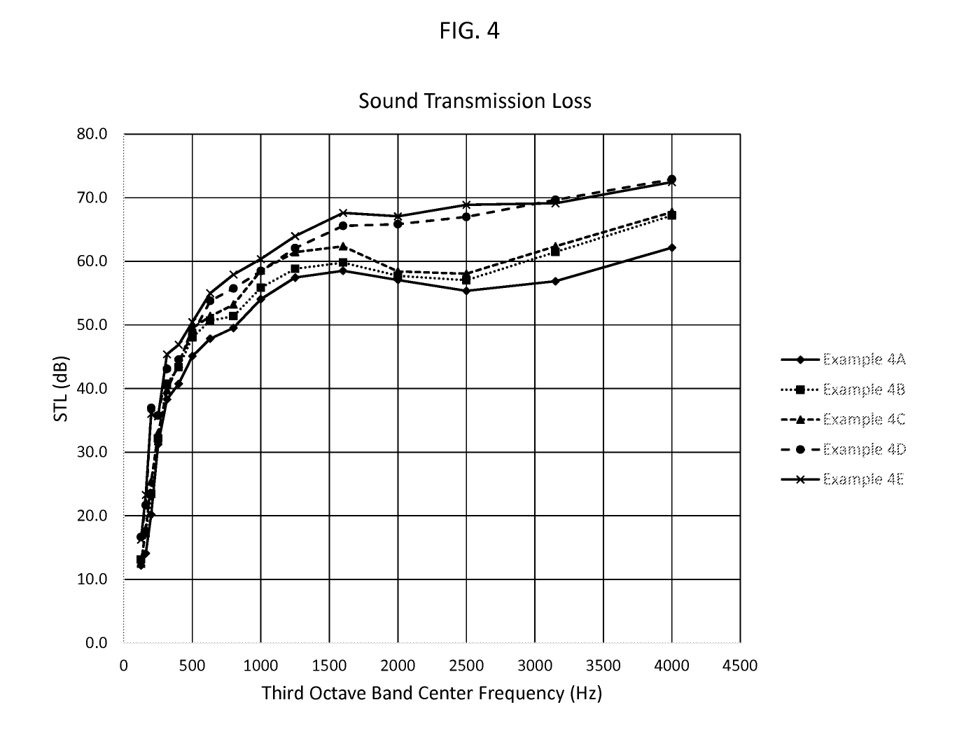

FIG. 4 is a graph comparing the sound transmission loss (STL) as a function of the third octave band center frequencies for several panels; and

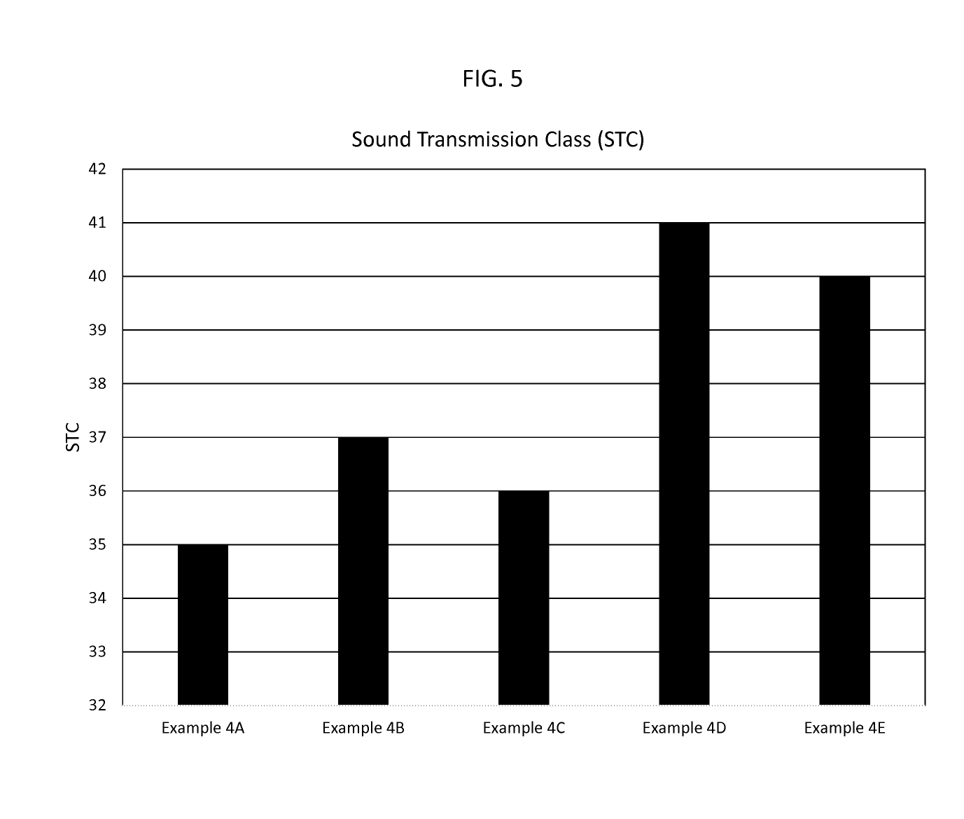

FIG. 5 is a graph comparing the sound transmission class (STC) for several panels.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “an” aromatic monoacid, “a” polyacid, “a” polyol, “an” aliphatic polyacid, and the like refers to one or more of any of these items.

As used herein, the transitional term “comprising” (and other comparable terms, e.g., “containing,” and “including”) is “open-ended” and is used in reference to compositions, methods, and respective component(s) thereof, that are essential to the invention, yet open to the inclusion of unspecified matter. The term “consisting essentially of” refers to those component(s) required for a given feature and permits the presence of component(s) that do not materially affect the properties or functional characteristic(s) of that feature. The term “consisting of” refers to compositions and methods that are exclusive of any other component not recited in that description of the feature.

The present invention includes a laminated panel 10 as shown in FIG. 1. The layers in the structure shown in FIG. 1 are shown as oriented horizontally. It should be understood that the laminated panel of the present invention may be used in a horizontal orientation or may be oriented vertically when placed on a vertical wall or door or at an angle when placed on ceilings or floors. A first layer 12 and a second layer 14 may be produced from a standard gypsum material and may be about ¼ inch thick. Other materials and thicknesses may be used for the layers as desired. For example, the first and second layers 12, 14 may be a cement based board, wood, magnesium oxide-based. board or calcium silicate board or the like. The laminated panel includes a glue layer (constrained layer) 16 extending between an internal surface 18 of the first layer 12 and an internal surface 20 of the second layer 14 and at least partially covering the internal surfaces thereof. The glue layer 16 includes an aqueous dispersion of polymeric acrylic microparticles (described below) and additives including fillers, tackifiers, plasticizers and the like. Suitable fillers for improving the vibration and sound dampening capabilities of the glue layer include mica, powdered slate, montmorillonite flakes, glass flakes, metal flakes, graphite, talc, iron oxide, clay minerals, cellulose fibers, mineral fibers, carbon fibers, glass or polymeric fibers or beads, ferrite, calcium carbonate, calcium magnesium carbonate (e.g. dolomite), barytes, ground natural or synthetic rubber, silica, aluminum hydroxide, alumina powder and mixtures thereof. Tackifiers are compounds which can increase the tack of the adhesive and the stiffness of the surface. Examples of tackifiers include plant-based compounds such as gum rosin (also known as colophony, the oleoresin of a living pine tree), starch, and synthetic polymeric dispersions such as waterborne polymeric tackifier dispersions (e.g. Aquatac 6025). A plasticizer may be included to ensure dissolution of the gum rosin. Suitable plasticizers include phthalates, adipates, gluterates, sebacates, benzoates, or any other plasticizer commonly used in PVC sealant formulations. Alternately, solvents such as glycols could be used but may be avoided due to undesirable volatility when used in the construction industry. A suitable biobased plasticizer is itaconate, based on itaconic acid (such as that produced from potatoes) dissolved in a solvent such as 2-ethyl hexanol, and/or diethylene glycol. The filler material may comprise 20 to 90 weight percent of the glue layer, with the plasticizer and gum rosin each comprising 5 to 25 weight percent.

The compositions of the present invention can include a variety of optional ingredients and/or additives that are somewhat dependent on the particular application of the composition, such as dyes or pigments such as carbon black or graphite, reinforcements, thixotropes, accelerators, surfactants, extenders, stabilizers, corrosion inhibitors, diluents, blowing agents and antioxidants.

The thickness of the glue layer 16 may be varied depending on the desired sound attenuation needed by the laminated panel. The laminated panel may be produced by applying a glue layer 16 to the first layer 12 in a thickness of 0.2 mm to 0.6 mm. The glue layer 16 is applied to the bottom surface 18 of the first layer 12, over a desired area. Different application techniques can be used such as: using a trowel out of a pail, squeezing a bead out of a tube, or pressure pumping the glue through a nozzle. If necessary, a draw down bar can be used subsequently to create a more even and controlled film thickness. The second layer 14 is then placed on top of the first layer 12, with the top surface 20 being in contact with the glue layer 16, The assembled pane is then left to rest, laying on a horizontal surface, for a minimum of 2-3 hours.

As shown in FIG. 2, a laminated panel 100 may include first and second layers 12, 14 as well as a constrained (glue) layer 16 and further includes an extensional layer 52 on an external surface 54 of first layer 12. As used herein, “constrained layer” refers to a layer of glue having a barrier structure on either side thereof as shown in FIG. 1. An extensional layer as used herein refers to a glue layer having a structural layer on only one side thereof as shown in FIG. 2. Either or both of the constrained layer 16 and extensional layer 52 may be produced from a viscoelastic material, such as an aqueous dispersion of microparticles. By “viscoelastic” it is meant that the material exhibits both viscous properties (resisting shear flow and strain linearly with time when stress is applied) and elastic properties (quickly returning to original state once stress is released) when undergoing deformation.

The constrained (glue) layer 16 and the extensional layer (coating) 52 may be produced from aqueous dispersion of polymeric acrylic microparticles. By “microparticles” it is meant particles having a mean diameter of 0.01 to 10 microns, or 0.05 to 0.5 microns, with less than 20 percent of the particles having a mean diameter greater than 5 microns or greater than 1 micron as measured using a particle size analyzer such as the Coulter N4 instrument, as disclosed in U.S. Pat. No. 6,531,541 col. 9, lines 21-47, incorporated herein by reference. The microparticles may be provided in an aqueous dispersion having 20 to 70 weight percent solids.

The microparticles may be prepared from a reaction mixture comprising (1) a hydroxy-functional monomer such as a hydroxyalkyl (meth)acrylate and/or a caprolactone adduct thereof, (2) an acid-functional monomer such as an ethylenically unsaturated carboxylic acid monomer and (3) another ethylenically unsaturated monomer such as a (meth)acrylate monomer. Preparation of the polymeric acrylic microparticles and other compositions for the polymeric acrylic microparticles that may be used, are disclosed in U.S. Pat. No. 6,531,541, col. 3, line 49-col. 7, line 40, and the Examples therein, incorporated herein by reference.

The hydroxy-functional monomer (1) may be hydroxyalkyl acrylates and (meth)acrylates, optionally having 2 to 6 carbon atoms in the hydroxyl alkyl group, such as hydroxyethyl acrylate, hydroxypropyl acrylate, 4-hydroxybutyl acrylate, hydroxy-functional adducts of caprolactone and hydroxylalkyl acrylates, and corresponding (meth)acrylates.

Suitable ethylenically unsaturated carboxylic acid monomers (2) include acrylic acid, methacrylic acid, aeryloxypropionic acid, crotonic acid, fumaric acid, monoalkyl esters of fumaric acid, maleic acid, monoalkyl esters of maleic acid, itaconic acid, monoalkyl esters of itaconic acid, and mixtures thereof.

Suitable ethylenically unsaturated vinyl monomers (3) include alkyl esters of acrylic and methacrylic acids, such as methyl acrylate, ethyl acrylate, methyl (meth)acrylate, ethyl (meth)acrylate, butyl acrylate, butyl (meth)acrylate, 2-ethylhexyl acrylate. 2-ethylhexyl (meth)acrylate, 2-hydroxyethyl acrylate, 2-hydroxyethyl (meth)acrylate, hydroxypropyl (meth)acrylate, ethylene glycol di(meth)acrylate, isobornyl (meth)acrylate and lauryl (meth)acrylate; vinyl aromatics such as styrene and vinyl toluene; acrylamides such as N-butoxymethyl acrylamide; acrylonitriles; dialkyl esters of maleic and fumaric acids; vinyl and vinylidene halides; vinyl acetate; vinyl ethers; allyl ethers; allyl alcohols; derivatives thereof and mixtures thereof.

The hydroxy-functional monomer (1) may comprise 1 to 25 weight percent of the acrylic polymer microparticles, with the acid-funtional monomers (2) comprising 0.1 to 10 weight percent and the (meth)acrylate monomers (3) comprising 65 to 98.9 weight percent. The transition temperature of the acrylic polymer rnicroparticles may be greater than 10° C. or greater than 20° C.

The following examples are presented to demonstrate the general principles of the invention. The invention should not be considered as limited to the specific examples presented. All parts and percentages in the examples are by weight unless otherwise indicated.

### EXAMPLES

### Example 1A-1B

### Latex Compositions for Use in Glue

Latex compositions (Example 1A and Example 1B) were prepared using the materials listed in Table 1 in a four neck round bottom flask equipped with a thermometer, mechanical stirrer, condenser, nitrogen sparge and a heating mantle. Water and a small portion of pre-emulsion (under 5% of total pre-emulsion) were charged to the reactor with a small amount of ALIPAL surfactant and ammonium persulfate free radical initiator to form a seed. A pre-emulsion of the remaining monomers, surfactant and water were fed along with the initiator over a prescribed period of time (3 hours) at a reaction temperature of 80-85° C. using a nitrogen blanket. The latex was neutralized to a pH of about 8 with dimethyl amino ethanol and antibacterial agent was added. The final pH of each of the lattices was about 7.5-8.5, the nonvolatile content was 35-40%, the Brookfield viscosity was 50-200 cps (spindle #1, 50 rpm) and the particle size was 1000-2000 angstroms.

TABLE 1

| | Example 1A | Example 1B |
|---|---|---|
| | Acrylic latex | Acrylic latex |
| Components (weight, grams) | (theor. Tg 0° C.) | (theor. Tg −6.7° C.) |
| Monomer Components | | |
| Methyl (meth)acrylate | 0 | 524.7 |
| Butyl acrylate | 32.5 | 522.3 |
| Bisomer S20W/MPEG | 0 | 88.2 |
| 2000 MA¹ | | |
| Styrene | 483.9 | 0 |
| Ethylhexyl acrylate | 659.4 | 314.3 |
| Hydroxylethyl | 161.3 | 118.6 |
| (meth)acrylate | | |
| Methacrylic acid | 35.8 | 18.1 |
| Other Components | | |
| ALIPAL CO436² | 15.4 | 28.4 |
| IGEPAL CO-430³ | 6.8 | 0 |
| Ammonium persulfate | 6.5 | 5.7 |
| FOAMASTER MO 2111⁴ | 0.9 | 0 |
| PROXEL GXL⁵ | 17.8 | 0.7 |
| Volatiles | | |
| Dimethyl amino ethanol | 21.7 | 14.3 |
| Deionized water | 2557.8 | 2386.3 |

¹Methyl (PEG) (meth)acrylate
²Ammonium nonoxynol-4-sulfate
³Nonyl phenol ethoxylate
⁴Proprietary hydrocarbon from BASF
⁵Antibacterial from Arch Chemicals, Inc.

### Example 2

### Plasticizer for Use in Glue

A bio-based plasticizer was prepared using a four neck round bottom flask equipped with total distillation for water collection, a thermometer, mechanical stirrer, condenser, nitrogen sparge and a heating mantle. All the components listed in Table 2 were charged into the flask and set the temperature was set to 130° C. After the reaction was complete and the mixture was clear, the temperature was increased in stages of 10° C. up to 180° C. until the acid value reached between 10 and 15 mg KOH/g.

TABLE 2

| Component | Wt. % |
|---|---|
| Triphenyl phosphite | 0.20 |
| p-Toluene sulphonic acid | 0.1 |
| Itaconic acid | 33.8 |
| Ionol | 0.23 |
| 2-Ethylhexanol | 64.29 |
| Diethylene glycol | 1.38 |

### Examples 3A-3C

### Glue Compositions

In each of Examples 3A-3C, the components listed in Table 3 were mixed using a Speedmixer DAC 600 FVZ (commercially available from FlackTek, Inc). Two pre-mixes were prepared prior to formulating the coating composition. A first pre-mix of a sodium salt of condensed sulfonated naphthalene was prepared by mixing with water at 2350 rotations per minute (rpm) for about three minutes (Component 4). A second plasticizer pre-mix was prepared by mixing Brazilian gum rosin with the plasticizer composition of Example 2 in a 50:50 ratio and heating the mix to 80° C. until dissolved and then cooled prior to use.

After the pre-mixes were prepared, Components 1-7, 12 and 16 were weighed in a DAC mixing cup and mixed for one minute at 2350 rpm. Components 8-11 were then added to the mixture in the amounts listed in Table 3 and mixed in the DAC mixer for one minute at 2350 rpm. Afterwards, Components 13-15 were added to the mixture and mixed for another one minute at 2350 rpm. During the mixing process, the mixture was examined with a spatula to ensure uniformity as will be understood by those skilled in the art. The final step of the mixing process involved mixing the mixture with an air motor prop in a vacuum sealed apparatus for one minute at 28 to 30 inch of vacuum pressure. After the final mixing step with the air motor prop, the coating compositions were ready for testing.

TABLE 3

| | | Example | Example | Example |
|---|---|---|---|---|
| Components (in grams) | | 3A | 3B | 3C |
| 1 | Acrylic latex (Example 1A) | 31.46 | 26.6 | — |
| 2 | PVAE⁶ | — | 10.21 | — |
| 3 | Acrylic latex (Example 1B) | — | — | 80 |
| 4 | 33% Darvan #1 solution in | 0.43 | 0.4 | — |
| | water⁷ | | | |
| 5 | Foamaster MO 2111⁸ | 0.05 | 0.04 | — |
| 6 | Proxel TN⁹ | 0.05 | 0.04 | — |
| 7 | T-19088M¹⁰ | 0.43 | 0.4 | — |
| 8 | Dolocron 4512¹¹ | 56.23 | 52.19 | — |
| 9 | Microglass 9132¹² | 5.5 | 4.65 | — |
| 10 | Firebrake ZB¹³ | 4.66 | 4.32 | — |
| 11 | Hi-SIL T-152¹⁴ | 0.28 | 0.26 | — |
| 12 | Gum rosin in plasticizer (Ex. 2) | — | — | 50 |
| 13 | Acrysol ASE-60¹⁵ | — | — | 0.50 |
| 14 | Rheolate¹⁶ | 0.94 | 0.87 | 0.50 |
| 15 | Hi-Sil T-800¹⁷ | — | — | 3.00 |
| 16 | Triton H-66¹⁸ | — | — | 0.15 |

⁶Poly(vinyl alcohol) stabilized with vinyl acetate-ethylene, available as VINNAPAS ®460 from Wacker Polymers.
⁷Darvan #1, sodium salt of condensed sulfonated naphthalene available from R T Vanderbilt.
⁸Proprietary hydrocarbon from BASF.
⁹Anti-microbial solution from Arch Chemicals.
¹⁰Carbon black aqueous dispersion from Emerald Performance Materials.
¹¹Pulverized dolomite calcium magnesium carbonate from Specialty Minerals, Inc.
¹²Microglass 9132, available from Fibertec.
¹³Zinc borate from Polymer Additives Group.
¹⁴Hydrated amorphous silica from PPG Industries Inc.
¹⁵Rheology modifier water soluble acrylic polymer, available from Rohm & Haas.
¹⁶Rheology modifier water soluble acrylic emulsion, available from Elementiz.
¹⁷Synthetic precipitated silica from PPG Industries, Inc.
¹⁸Surfactant phosphate polyether ester, available from Dow Chemical.

### Examples 4A-4E

### Acoustic Panels

Five panels were prepared using the glue compositions of Examples 3A, 3B and, 3C and having a layered structure as detailed in Table 4.

TABLE 4

| | Example | | | | |
|---|---|---|---|---|---|
| | 4A | 4B | 4C | | |
| | Compar- | Compar- | Compar- | 4D | 4E |
| | ative | ative | ative | Inventive | Inventive |
| LAYER 1 | ½ in. thick drywall | | | ¼ in. thick drywall | |
| Surface density | 6.114 | 6.114 | 6.114 | 4.373 | 4.373 |
| (kg/m²) | | | | | |
| Density (g/cm³) | 0.493 | 0.493 | 0.493 | 0.683 | 0.683 |
| Thickness (mm) | 12.40 | 12.40 | 12.40 | 6.40 | 6.40 |
| CONSTRAINED | NONE | | | Example | Example |
| LAYER | | | | 3C | 3C |
| Surface density | — | — | — | 1.121 | 1.121 |
| (kg/m²) | | | | | |
| Density (g/cm³) | — | — | — | 2.797 | 2.797 |
| Thickness (mm) | — | — | — | 0.40 | 0.40 |
| LAYER 2 | NONE | | | ¼ in. thick drywall | |
| Surface density | — | — | — | 4.373 | 4.37 |
| (kg/m²) | | | | | |
| Density (g/cm³) | — | — | — | 0.683 | 0.68 |
| Thickness (mm) | — | — | — | 6.40 | 6.40 |
| EXTENSIONAL | NONE | Example | Example | NONE | Example |
| LAYER | | 3A | 3B | | 3A |
| Surface density | — | 5.368 | 7.232 | — | 5.37 |
| (kg/m²) | | | | | |
| Density (g/cm³) | — | 1.499 | 1.398 | — | 1.50 |
| Thickness (mm) | — | 3.59 | 5.17 | — | 3.59 |
| TOTAL | For the entire layered arrangement | | | | |
| Surface density | 6.114 | 11.482 | 13.346 | 9.87 | 15.235 |
| (g/m²) | | | | | |
| Density (g/cm³) | 0.493 | 0.718 | 0.759 | 0.75 | 0.907 |
| Thickness (mm) | 12.40 | 15.99 | 17.57 | 13.20 | 16.79 |

Acoustic tests were performed on the five panels to determine the Damping Loss Factor (DLF), the Sound Transmission Loss (STL), and the Sound Transmission Class (STC) for each panel.

Vibration damping performance was measured by determining the Damping Loss Factor (DLF) of a test beam sample. The test beam sample was approximately 30 inches long and 1 inch wide and was excited by a vibratory force input applied in the center of the test beam, i.e., the middle of the beam length. Except for the center point, where the beam was simultaneously supported and excited, the test beam was otherwise freely suspended, thus forming a center-midpoint balanced test beam arrangement. The vibration exciter, also called a shaker, vibrated the test beam at different frequencies, over the desired frequency range of interest that included a minimum of four vibration modes of the test beam. Both the applied force and the acceleration response were measured at the beam center point, where the force was applied, using an impedance head sensor. The frequency response function (FRF) curve was determined at the driving point using a two channel signal acquisition and spectrum analyzer hardware-software system, typically used in vibrations testing laboratories. In the FRF curve, peak amplitude values were observed at certain frequencies, called resonance frequencies, which corresponded to each vibration mode of the test beam. The damping performance was evaluated by determining the DLF using the half-power bandwidth method also known as the 3 dB down method (SAE J1637 and ASTM E756) at each resonance frequency observed on the FRF curve plot. The DU at a desired frequency of interest was then determined by linear interpolation between the values of the damping loss factors measured for two resonance frequencies, which were consecutively and respectively lower and higher than the desired frequency of interest. The DLF is a dimensionless quantity, with values between 0 and 1, where 1 corresponds to the highest damping and 0 corresponds to the lowest damping. Measurements were conducted in a temperature range of 22-26° C., which represents typical room temperature conditions.

Airborne Sound Transmission Loss (STL) was also determined according to ASTM E2249 and used to calculate a Sound Transmission Class rating (STC) according to ASTM E413.

To measure the STL, a diffuse airborne noise field created in a source room was allowed to pass through a test sample into a receiving room. The source room was a reverberation room, and the receiving room was a hemi-anechoic room. The test sample was assembled as a floor-ceiling partition. The overall size of the partition was 5 feet by 5 feet, equal to the size of the test window between the two rooms. The “floor” side, which faced the source room was composed of engineered wood planks fastened together as a floating floor layer installed on top of a ½ inch thick plywood subfloor, The plywood subfloor was fastened with nails to a joist frame made of 2 inch by 4 inch wood studs and built all around the perimeter of the test window, tightly filling the window opening. Additional 2 inch by 4 inch wood studs, spaced 16 inches apart, were also installed across the frame. The floor side of the test sample partition, the plywood subfloor and the joist frame, remained unchanged during all the testing. The “ceiling” side of the test sample partition, which faced the receiving room was made from the panel that was being tested, was fastened with drywall nails to the side of the joist frame opposing the plywood subfloor. Between the plywood subfloor, the ceiling layer arrangement, and the wood studs there were enclosed spaces, which remained empty.

The STL was measured at all third octave frequency bands with center frequencies between 100 Hz and 10,000 Hz. Sound intensity was measured and averaged over the entire area of the test sample facing the source room. The testing of each configuration was repeated five times, and the averaged STL data in each third octave frequency band was calculated as an arithmetic mean. Measurements were conducted in a temperature range of 22-26° C. The STC rating was subsequently calculated by using the averaged sound transmission loss data values measured at the third octave bands with center frequencies between 125 Hz and 4000 Hz.

Results of the testing are given in Tables 5-7 and shown in FIGS. 3-5. The addition of a constrained layer of glue (Inventive Example 4D) or a constrained layer of glue in combination with an extensional layer of glue (Inventive Example 4E) to the drywall significantly improved (increased) the damping loss factor, the sound transmission loss, and the sound transmission class for the laminated structures over drywall alone (Comparative Example 4A) and drywall with only an extensional layer of glue (Comparative Examples 4B and 4C).

TABLE 5
Damping Loss Factor (DLF)

| Liner | | | | | |
|---|---|---|---|---|---|
| Interpolation | Example | | | | |
| Frequency (Hz) | 4A | 4B | 4C | 4D | 4E |
| 125 | 0.028 | 0.093 | 0.162 | 0.328 | 0.400 |
| 160 | 0.024 | 0.091 | 0.163 | 0.350 | 0.360 |
| 200 | 0.019 | 0.087 | 0.163 | 0.358 | 0.336 |
| 250 | 0.013 | 0.083 | 0.164 | 0.339 | 0.311 |
| 315 | 0.014 | 0.080 | 0.162 | 0.315 | 0.277 |
| 400 | 0.014 | 0.078 | 0.156 | 0.284 | 0.242 |
| 500 | 0.014 | 0.075 | 0.149 | 0.273 | 0.232 |
| 630 | 0.015 | 0.072 | 0.139 | 0.268 | 0.219 |
| 800 | 0.013 | 0.069 | 0.130 | 0.260 | 0.208 |
| 1000 | 0.011 | 0.065 | 0.121 | 0.244 | 0.201 |
| 1250 | 0.010 | 0.060 | 0.110 | 0.223 | 0.185 |
| 1600 | 0.010 | 0.058 | 0.103 | 0.196 | 0.156 |
| 2000 | 0.011 | 0.058 | 0.096 | | |
| 2500 | 0.012 | | | | |

TABLE 6
Sound Transmission Loss (STL)

| Third Octave | | | | | |
|---|---|---|---|---|---|
| Band Center | Example | | | | |
| Frequency (Hz) | 4A | 4B | 4C | 4D | 4E |
| 125 | 12.2 | 13.1 | 12.5 | 16.7 | 16.2 |
| 160 | 14.1 | 17.3 | 18.0 | 21.7 | 23.3 |
| 200 | 20.2 | 23.4 | 25.4 | 36.9 | 36.0 |
| 250 | 31.3 | 32.1 | 33.0 | 35.8 | 35.7 |
| 315 | 38.3 | 40.8 | 39.8 | 43.1 | 45.4 |
| 400 | 40.7 | 43.4 | 43.9 | 44.6 | 46.9 |
| 500 | 45.1 | 48.1 | 49.5 | 48.5 | 50.4 |
| 630 | 47.8 | 50.7 | 51.4 | 53.8 | 55.0 |
| 800 | 49.5 | 51.4 | 53.2 | 55.7 | 57.9 |
| 1000 | 54.1 | 55.9 | 58.6 | 58.5 | 60.4 |
| 1250 | 57.5 | 58.8 | 61.5 | 62.1 | 64.0 |
| 1600 | 58.5 | 59.8 | 62.4 | 65.6 | 67.6 |
| 2000 | 57.1 | 57.7 | 58.4 | 65.9 | 67.1 |
| 2500 | 55.4 | 57.0 | 58.1 | 67.0 | 68.9 |
| 3150 | 56.9 | 61.5 | 62.4 | 69.7 | 69.1 |
| 4000 | 62.2 | 67.2 | 67.8 | 72.9 | 72.5 |

TABLE 7
Sound Transmission Class (STC)

| | Example | | | | |
|---|---|---|---|---|---|
| | 4A | 4B | 4C | 4D | 4E |
| STC | 35 | 37 | 36 | 41 | 40 |

The present invention further includes the subject matter of the following clauses.

Clause 1: A laminated panel comprising a first layer having an internal surface and an external surface; a second layer having an internal surface and an external surface; and a glue layer extending between and at least partially covering said internal surface of said first and second layers, said glue layer produced from an aqueous dispersion comprising polymeric acrylic microparticles.

Clause 2: The panel of clause 1, wherein said polymeric acrylic microparticles are prepared from a reaction mixture comprising (i) a hydroxy-functional ethylenically unsaturated monomer, (ii) an acid-functional ethylenically unsaturated monomer, and (iii) an ethylenically unsaturated monomer that is different from monomers (i) and (ii). The hydroxy-funtional monomer (1) may comprise 1 to 25 weight percent of the acrylic polymer microparticles, with the acid-functional monomers (2) comprising 0.1 to 10 weight percent and the (meth)acrylate monomers (3) comprising 65 to 98.9 weight percent. The filler material may comprise 20 to 90 weight percent of the glue layer, with the plasticizer and gum rosin each comprising 5 to 25 weight percent.

Clause 3: The panel of clause 2, wherein said hydroxy-functional ethylenically unsaturated monomer (i) comprises a hydroxyalkyl (meth)acrylate, such as hydroxyethyl (meth)acrylate, or a caprolactone adduct thereof or both, including mixtures of different hydroxy-functional ethylenically unsaturated monomers.

Clause 4: The panel of any one of clauses 2-3, wherein said acid-functional ethylenically unsaturated monomer (ii) comprises an ethylenically unsaturated carboxylic acid monomer, such as (meth)acrylic acid, including mixtures of different acid-functional ethylenically unsaturated monomers.

Clause 5: The panel of any one of clauses 2-4, wherein said ethylenically unsaturated monomer (iii) is selected form alkyl esters of (meth)acrylic acid, preferably containing from 1 to 20 atoms in the alkyl group, such as methyl (meth)acrylate, ethyl (meth)acrylate, butyl (meth)acrylate, and 2-ethylhexyl (meth)acrylate; poly(alkylene glycol) alkyl ether (meth)acrylates, preferably poly(ethylene glycol) alkyl ether (meth)acrylates such as poly(ethylene glycol) methyl ether (meth)acrylates; vinyl aromatic monomers such as styrene; and mixtures thereof.

Clause 6: The panel of clause 5, wherein said ethylenically unsaturated monomer comprises an alkyl (meth)acrylate monomer.

Clause 7: The panel of any one of clauses 1-6, wherein said aqueous dispersion further comprises a plasticizer.

Clause 8: The panel of any one of clauses 1-7, wherein said plasticizer comprises an itaconate plasticizer.

Clause 9: The panel of any one of clauses 1-8, wherein said aqueous dispersion further comprises rosin.

Clause 10: The panel of any one of clauses 1-9, wherein said aqueous dispersion further comprises a filler material, preferably selected from mica, powdered slate, montmorillonite flakes, glass flakes, metal flakes, graphite, talc, iron oxide, clay minerals, cellulose fibers, mineral fibers, carbon fibers, glass or polymeric fibers or beads, ferrite, calcium carbonate, calcium magnesium carbonate (e.g. dolomite), barytes, ground natural or synthetic rubber, silica, aluminum hydroxide, alumina powder and mixtures thereof.

Clause 11: The panel of clause 10, wherein said aqueous dispersion comprises the filler material in an amount of from 20 to 90 weight percent, based on total solids of the aqueous dispersion.

Clause 12: The panel of any sine of clauses 1-11, further comprising a coating layer provided on at least a portion of at least one of said external surfaces, said coating layer produced from an aqueous dispersion as defined in any one of clauses 1-11.

Clause 13: The panel of clause 12, wherein said coating layer is prepared from an aqueous dispersion which is identical with the aqueous dispersion from which the glue layer is prepared.

Clause 14: The panel of clause 12, wherein said coating layer is prepared from an aqueous dispersion which is different from the aqueous dispersion from which the glue layer is prepared.

Clause 15: The panel of clause 14, wherein said coating layer is prepared from an aqueous dispersion comprising a filler material and preferably, said glue layer is prepared from an aqueous dispersion comprising rosin.

Clause 16: The panel of any one of clauses 1-15, Wherein said first layer or said second layer or both comprise a material independently selected from gypsum, cement, wood, magnesium oxide, and calcium silicate.

Clause 17: The panel of clause 16, wherein said first layer or said second layer or both comprise gypsum, preferably said first layer or said second layer or both are a gypsum board.

Clause 18: The panel of clause 16, wherein said first layer or said second layer or both are independently selected from a cement board, a magnesium oxide board, and a calcium silicate board.

Clause 19: The panel of any one of clauses 1-18, wherein said glue layer has a thickness within the range of from 0.2 to 0.6 mm.

Clause 20: The panel of any one of clauses 12-15 and 16-19 inasmuch as referring back to claim 12, wherein said coating layer has a thickness within the range of 1 to 10 mm.

Clause 21: The panel of any one of clauses 1 to 20, wherein the glue layer, the coating layer or both are made of a viscoelastic material.

Clause 22: A laminated panel comprising a first portion comprising a constrained layer of viscoelastic material; and a second portion comprising an extensional layer of viscoelastic material.

Clause 23: The panel of clause 22, wherein said first portion further comprises a pair of constraining members, said constrained layer being received between said constraining members.

Clause 24: The panel of any one of clauses 22-23, wherein said constrained layer is produced from an aqueous dispersion comprising as defined in any one of clauses 1-15.

Clause 25: The panel of any one of clauses 23-24, wherein said constraining members comprise a material independently selected from gypsum, cement, wood, magnesium oxide, and calcium silicate, preferably comprise gypsum.

Clause 26: The panel of any one of clauses 22-25, wherein said extensional layer is produced from an aqueous dispersion comprising as defined in any one of claims 1-15.

Clause 27: The panel of clause 26 inasmuch as referring back to clause 24, wherein said extensional layer is prepared from an aqueous dispersion comprising a filler material and preferably, said constrained layer is prepared from an aqueous dispersion comprising rosin.

Clause 28: Use of the panel of any one of clauses 1-27 for sound and vibration damping.

Clause 29: Use of the panel of any one of clauses 1-27 in a soundproofing or sound damping application, preferably to reduce the transmission of sound through walls, ceilings, or floors.

Although the present invention has been described with reference to specific details of certain features thereof, it is not intended that such details should be regarded as limitations upon the scope of the invention except insofar as they are included in the accompanying claims.

The invention claimed is

1. A laminated panel comprising:
a first layer having an internal surface and an external surface;
a second layer having an internal surface and an external surface; and
a glue layer extending between and at least partially covering said internal surface of said first and second layers, said glue layer produced from an aqueous dispersion of polymeric acrylic microparticles.

2. The panel of claim 1, wherein said polymeric acrylic microparticles are prepared from a reaction mixture comprising (i) a hydroxy-functional monomer, (ii) an acid functional monomer, and (iii) an ethylenically unsaturated monomer that is different from monomer (i).

3. The panel claim 1, wherein said hydroxy-functional monomer (i) comprises a hydroxyalkyl (meth)acrylate or a caprolactone adduct thereof or both.

4. The panel of claim 2, wherein said acid-functional monomer (ii) comprises an ethylenically unsaturated carboxylic acid monomer.

5. The panel of claim 2, wherein said ethylenically unsaturated monomer (iii) comprises a (meth)acrylate monomer.

6. The panel of claim 2, wherein said aqueous dispersion further comprises a plasticizer.

7. The panel of claim 6, wherein said plasticizer comprises an itaconate plasticizer.

8. The panel of claim 2, wherein said aqueous dispersion further comprises rosin.

9. The panel of claim 1, further comprising a coating composition provided on at least a portion of at least one of said external surfaces, said coating composition comprising another aqueous dispersion of polymeric acrylic microparticles.

10. The panel of claim 1, Wherein said first layer or said second layer or both comprise gypsum.

11. A laminated panel comprising:
a first portion comprising a constrained layer of viscoelastic material; and
a second portion comprising an extensional layer of viscoelastic material.

12. The panel of claim 11, wherein said first portion further comprises a pair of constraining members, said constrained layer being received between said constraining members.

13. The panel of claim 11, wherein said constrained layer comprises a polymeric material produced from an aqueous dispersion of polymeric acrylic microparticles.

14. The panel of claim 13, wherein said polymeric acrylic microparticles are prepared from a reaction mixture comprising (i) a hydroxy-functional monomer, (ii) an acid-functional monomer, and (iii) an ethylenically unsaturated monomer that is different from monomer (i).

15. The panel of claim 14, wherein said aqueous dispersion further comprises a plasticizer.

16. The panel of claim 15, wherein said plasticizer comprises an itaconate plasticizer.

17. The panel of claim 14, wherein said aqueous dispersion further comprises rosin.

18. The panel of claim 12, wherein said constraining members comprise gypsum.

19. The panel of claim 11, wherein said extensional layer comprises a polymeric material produced from an aqueous dispersion of polymeric acrylic microparticles and a filler material comprising 20 to 90 weight percent of the coating layer composition.

20. The panel of claim 19, wherein said polymeric acrylic microparticles are prepared from a reaction mixture comprising (i) a hydroxy-functional monomer, (ii) an acid-functional monomer, and (iii) an ethylenically unsaturated monomer that is different from monomer (i).
